(19) United States
(12) Patent Application Publication
(10) Pub. No.: US 2025/0058628 A1
(43) Pub. Date: Feb. 20, 2025

(54) INFORMATION DISPLAY METHOD AND RELATED APPARATUS

(71) Applicant: TENCENT TECHNOLOGY (SHENZHEN) COMPANY LIMITED, Shenzhen (CN)

(72) Inventor: Weizhi CHEN, Shenzhen (CN)

(21) Appl. No.: 18/939,107

(22) Filed: Nov. 6, 2024

Related U.S. Application Data
(63) Continuation of application No. PCT/CN2023/124428, filed on Oct. 13, 2023.

(30) Foreign Application Priority Data
Nov. 18, 2022 (CN) 202211447544.3

(51) Int. Cl. B60K 35/23; G06T 11/00; G06V 20/58

(52) U.S. Cl. CPC B60K 35/23; G06T 11/00; G06V 20/58; B60K 2360/177

(57) ABSTRACT

An information display method includes: projecting, through an augmented reality head up display (AR HUD) device on a target vehicle, an information display area on a front windshield of the target vehicle, the information display area including at least a virtual prompt element corresponding to a key object, the key object being an object in a driving environment where the target vehicle is located, and a display position of the virtual prompt element corresponding to a position of the key object in the driving environment; and changing a position of the information display area on the front windshield in response to a change of the key object meeting a preset condition, wherein the information display area includes a virtual prompt element corresponding to the key object that is changed.

### CROSS-REFERENCES TO RELATED APPLICATIONS

This application is a continuation application of PCT Patent Application No. PCT/CN2023/124428, filed on Oct. 13, 2023, which claims priority to Chinese Patent Application No. 202211447544.3, filed with China National Intellectual Property Administration on Nov. 18, 2022 and entitled “INFORMATION DISPLAY METHOD AND RELATED APPARATUS”, the entire contents of both of which are incorporated herein by reference.

### FIELD OF THE TECHNOLOGY

The present disclosure relates to the field of traffic technologies, and in particular, to a head up display (HUD) technology.

### BACKGROUND OF THE DISCLOSURE

Augmented reality head up display (AR HUD) is a combination of an AR technology and a HUD system. The AR technology skillfully integrates virtual information with the real world, to achieve “enhancement” of the real world. The HUD system is configured to project driving assistance information such as a vehicle speed and navigation indication onto a front windshield of a vehicle, so that a driver sees the driving assistance information without lowering or turning his/her head. An AR HUD device is configured to detect an actual driving environment, and project a virtual element corresponding to related information in the actual driving environment onto the front windshield of the vehicle, to present helpful prompt to the driver.

Currently, a field of view (FOV) for imaging of the AR HUD device is generally relatively small, is usually only 13×5 degrees, and a position of the FOV generally remains constant. Therefore, only information within a specific local FOV in the actual driving environment can often be prompted through AR display based on the FOV. For example, only traffic signs on a road surface (such as an intersection lane sign and a lane line sign) can be prompted. Prompt information provided by an AR HUD device is not rich enough, and therefore usage experience is poor for the driver.

### SUMMARY

Embodiments of the present disclosure provide an information display method and a related apparatus, so as to enrich prompt information provided by an augmented reality head up display (AR HUD) device, thereby improving usage experience of a driver.

In view of this, a first aspect of the present disclosure provides an information display method, the method being performed by an electronic device, and including: projecting, through an augmented reality head up display (AR HUD) device on a target vehicle, an information display area on a front windshield of the target vehicle, the information display area including at least a virtual prompt element corresponding to a key object, the key object being an object in a driving environment where the target vehicle is located, and a display position of the virtual prompt element corresponding to a position of the key object in the driving environment; and changing a position of the information display area on the front windshield in response to a change of the key object meeting a preset condition, so that the information display area includes a virtual prompt element corresponding to the key object that is changed.

A second aspect of the present disclosure provides an information display apparatus, the apparatus including: a projection display module, configured to project, through an augmented reality head up display (AR HUD) device on a target vehicle, an information display area on a front windshield of the target vehicle, the information display area including at least a virtual prompt element corresponding to a key object, the key object being an object in a driving environment where the target vehicle is located, and a display position of the virtual prompt element corresponding to a position of the key object in the driving environment; and a position change module, configured to change a position of the information display area on the front windshield in response to a change of the key object meeting a preset condition, so that the information display area includes a virtual prompt element corresponding to the key object that is changed.

A third aspect of the present disclosure provides an electronic device, the electronic device including a processor and a memory, the memory being configured to store a computer program; and the processor being configured to perform the operations of the information display method described in the foregoing first aspect based on the computer program.

A fourth aspect of the present disclosure provides a non-transitory computer-readable storage medium, the computer-readable storage medium being configured to store a computer program, the computer program being configured for performing the operations of the information display method described in the foregoing first aspect.

It may be learned from the foregoing technical solutions that the embodiments of the present disclosure have the following advantages:

The embodiments of the present disclosure provide the information display method. According to the method, a position of a field of view (FOV) for imaging of the AR HUD device may be dynamically adjusted based on a change of the key object in the driving environment where the target vehicle is located. In other words, the position of the information display area generated through the projection of the AR HUD device and through the front windshield of the target vehicle on the front windshield may be dynamically adjusted, so that the virtual prompt element corresponding to the key object in the driving environment may be continuously displayed in the information display area, and it is ensured that the display position of the virtual prompt element corresponds to the position of the key object in the driving environment, to provide more realistic prompt information for a driver. According to the information display method provided in the embodiments of the present disclosure, when the key object changes to another FOV from an FOV to which the AR HUD device currently pays attention, the AR HUD device may adjust the position of the information display area generated through the projection thereof on the front windshield, so that the information display area corresponds to the changed FOV. In this way, the information prompted by the AR HUD device is no longer limited to a specific FOV, and may dynamically correspond to a wider FOV. Correspondingly, the driver may learn richer prompt information through the dynamic information display area, thereby improving usage experience.

### BRIEF DESCRIPTION OF THE DRAWINGS

FIG. 1 is a schematic diagram of an application scenario of an information display method according to an embodiment of the present disclosure.

FIG. 2 is a schematic flowchart of an information display method according to an embodiment of the present disclosure.

FIG. 3 is a schematic diagram of an imaging plane of an augmented reality head up display (AR HUD) device according to an embodiment of the present disclosure.

FIG. 4 is a schematic diagram of an exemplary information display area according to an embodiment of the present disclosure.

FIG. 5 is a schematic diagram of changing a display position of an information display area according to an embodiment of the present disclosure.

FIG. 6 is a schematic diagram of changing a display position of an information display area according to an embodiment of the present disclosure.

FIG. 7 is a schematic diagram of an exemplary information display area according to an embodiment of the present disclosure.

FIG. 8 is a schematic flowchart of a method for determining a display position of an information display area according to an embodiment of the present disclosure.

FIG. 9 is a schematic diagram of a vehicle coordinate system of a target vehicle according to an embodiment of the present disclosure.

FIG. 10 is a schematic diagram of a movable range of a target imaging area according to an embodiment of the present disclosure.

FIG. 11 is a schematic structural diagram of an information display apparatus according to an embodiment of the present disclosure.

FIG. 12 is a schematic structural diagram of a terminal device according to an embodiment of the present disclosure.

### DESCRIPTION OF EMBODIMENTS

An information display method provided in embodiments of the present disclosure may be performed by an electronic device. The electronic device may specifically be a controller for controlling an augmented reality head up display (AR HUD) device mounted on a vehicle. The controller may specifically be integrated into the AR HUD device, or may be independent of the AR HUD device. The controller may control an image generated through projection of the AR HUD device on the one hand, and may control a display position of the image generated through projection of the AR HUD device on the other hand.

To facilitate understanding of the information display method provided in the embodiments of the present disclosure, an application scenario of the information display method is exemplarily described below by using an example in which the controller is independent of the AR HUD device.

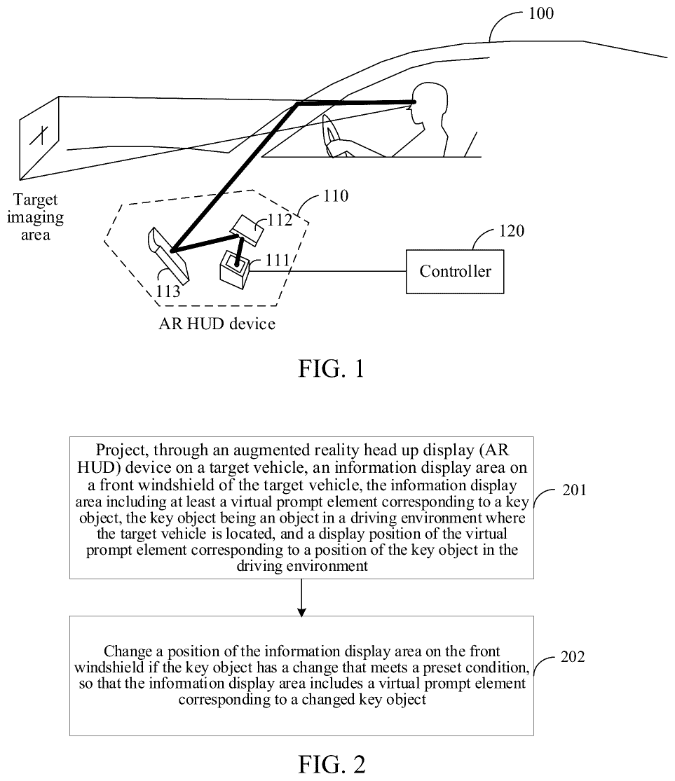

FIG. 1 is a schematic diagram of an application scenario of an information display method according to an embodiment of the present disclosure. As shown in FIG. 1, the application scenario includes a target vehicle 100. An AR HUD device 110 and a controller 120 are mounted on the target vehicle 100. The controller 120 may communicate with the AR HUD device 110 through a wired network or a wireless network. The controller 120 is configured to control an information display area generated through projection of the AR HUD device 110 and through a front windshield of the target vehicle 100.

In an actual application, the controller 120 may transmit control data to a light engine 111 in the AR HUD device 110, and control, through the control data, the light engine 111 to generate the information display area. For example, the controller 120 may transmit image rendering data to the light engine 111, so that the light engine 111 renders the information display area based on the image rendering data. The light engine 111 is configured to display an image generated through rendering by the light engine. A ray of light of the image is reflected by reflective devices 112 and 113 in the AR HUD device 110, and is finally projected onto the front windshield of the target vehicle 100. An information display area corresponding to the image generated by the light engine 111 is displayed through the front windshield. The information display area corresponds to a target imaging area on a virtual image imaging plane of the AR HUD device 110.

The information display area generated through the projection of the AR HUD device 110 includes a virtual prompt element corresponding to a key object. The key object herein is an object in the driving environment where the target vehicle 100 is located, and is specifically an object to which a driver needs to pay attention. The key object may be, for example, a lane line, a vehicle, and a pedestrian on a road surface. The virtual prompt element herein is a virtual element created based on an AR technology and configured for prompting existence of the key object. The virtual prompt element may be, for example, a virtual arrow configured for indicating a lane direction or a navigation direction, a virtual vehicle element configured for indicating a vehicle, or a virtual pedestrian element configured for indicating a pedestrian. In this embodiment of the present disclosure, a display position of the virtual prompt element corresponding to the key object in the information display area corresponds to a position of the key object in the driving environment. For example, from an angle of view of the driver, the virtual arrow configured for indicating the lane direction overlaps a lane direction sign on the road surface, the virtual vehicle element configured for indicating the vehicle overlaps a position of the vehicle, the virtual pedestrian element configured for indicating the pedestrian overlaps a position of the pedestrian, or the like.

When the key object in the driving environment has a change that meets a preset condition, the controller 120 needs to control the AR HUD device 110 to change a position of the target imaging area corresponding to the information display area on the virtual image imaging plane, to correspondingly change a position of the information display area on the front windshield of the target vehicle 100. Exemplarily, when the key object is beyond a field of view (FOV) currently corresponding to the information display area, the controller 120 may determine an imaging position of the virtual prompt element corresponding to the key object on the virtual image imaging plane of the AR HUD device 110 based on the position of the key object in the driving environment, and then adjust the position of the target imaging area corresponding to the information display area on the virtual image imaging plane, so that the target imaging area can cover the imaging position of the virtual prompt element corresponding to the key object. The position of the target imaging area on the virtual image imaging plane is adjusted, so that the adjustment of the position of the information display area on the front windshield may be achieved, and the target imaging area can cover the imaging position of the virtual prompt element corresponding to the key object, so as to correspondingly ensure that the information display area includes the virtual prompt element corresponding to the key object.

The application scenario shown in FIG. 1 is merely an example. No limitation is imposed on the application scenario of the information display method provided in the embodiments of the present disclosure herein.

The information display method provided in the embodiments of the present disclosure is described in detail below through method embodiments.

FIG. 2 is a schematic flowchart of an information display method according to an embodiment of the present disclosure. As shown in FIG. 2, the information display method includes the following operations:

Operation 201: Project, through an augmented reality head up display (AR HUD) device on a target vehicle, an information display area on a front windshield of the target vehicle, the information display area including at least a virtual prompt element corresponding to a key object, the key object being an object in a driving environment where the target vehicle is located, and a display position of the virtual prompt element corresponding to a position of the key object in the driving environment.

In this embodiment of the present disclosure, the AR HUD device on the target vehicle may generate, through projection, the information display area displayed through the front windshield of the target vehicle. Specifically, a light engine in the AR HUD device may receive image rendering data transmitted by a controller, and then render and display a target image based on the image rendering data, the target image corresponding to the information display area. A light reflection device in the AR HUD device projects the information display area corresponding to the target image onto the front windshield of the target vehicle for display by reflecting a light ray of the target image generated by the light engine. In this way, the information display area is generated through the front windshield of the target vehicle.

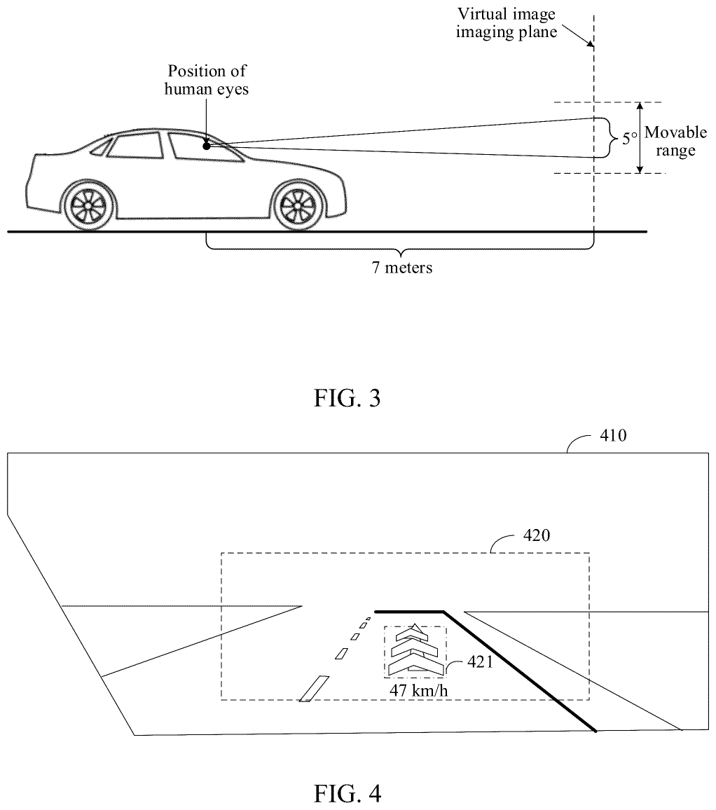

The information display area generated through the front windshield of the target vehicle corresponds to a target imaging area on an imaging plane of the AR HUD device. FIG. 3 is a schematic diagram of an imaging plane of an AR HUD device according to an embodiment of the present disclosure. As shown in FIG. 3, the AR HUD device uses a front windshield of a vehicle as a projection medium to form an image through reflection. The image formed on the front windshield corresponds to a virtual image in a corresponding imaging area on a virtual image imaging plane of the AR HUD device, and a size of the imaging area corresponds to an FOV of the AR HUD device. Generally, the virtual image imaging plane of the AR HUD device is perpendicular to the ground, and is located in a position about 7 meters in front of a driver seat of the vehicle. The FOV of the AR HUD device is 13×5 degrees. The FOV indicates an included angle formed by eyes of a driver and an edge of a virtual image that can be seen by the driver. The FOV being equal to 13×5 degrees indicates that a transverse perspective of the driver for the virtual image is 13 degrees and a longitudinal perspective is 5 degrees.

In this embodiment of the present disclosure, a position of an information display area on the front windshield may be adjusted through adjusting a position of a target imaging area on the imaging plane corresponding to the information display area. A specific implementation of determining the position of the information display area on the front windshield and a specific implementation of adjusting the position of the information display area on the front windshield are to be described in detail in another method embodiment below.

The information display area generated through the projection of the AR HUD device includes at least a virtual prompt element corresponding to a key object. The key object herein is an object in the driving environment where the target vehicle is located, and may specifically be an object to which a driver needs to pay attention in the driving environment. The key object may be determined based on a reference image captured by a front camera of the target vehicle. Exemplarily, image detection may be performed on the reference image captured by the front camera of the target vehicle, objects of specific types included in the reference image may be determined as candidate key objects, and then based on a preset key object determining rule, an object to which the driver needs to pay attention is selected from the candidate key objects included in the reference image as the key object. The key object may be, for example, a traffic sign on a road surface (such as an intersection lane sign or a lane line sign), and for another example, may be a vehicle, a pedestrian, or an obstacle on the road surface. A type of the key object is not limited in the present disclosure.

The key object in the driving environment is different from a common object in the driving environment. The key object in the driving environment includes an object that has impact on driving safety, which may specifically be an object that may cause a traffic accident in the driving environment, for example, a vehicle, a pedestrian, or an obstacle at a distance from the target vehicle less than a preset distance threshold (for example, 20 meters), or may specifically be an object that indicates a traffic rule in the driving environment, for example, an intersection lane sign, a lane line sign, or a speed limit sign. However, the common object in the driving environment may be any object that has no impact on the driving safety, for example, a vehicle, a pedestrian, or an obstacle at a distance from the target vehicle greater than or equal to the preset distance threshold.

In an actual application, an evaluation condition corresponding to the foregoing key object may be preset. When it is detected that an object that meets the evaluation condition exists in the driving environment, the object is correspondingly used as the key object. Exemplarily, the foregoing evaluation condition may specify the type of the key object (for example, a vehicle, a person, an animal, an obstacle, or a traffic sign), and may further specify a requirement for the distance from the target vehicle. No limitation is imposed on the evaluation condition of the key object herein in this embodiment of the present disclosure.

The virtual prompt element corresponding to the key object is a virtual element generated based on an AR technology and configured for prompting existence of the key object. Through the virtual prompt element, the driver may be guided to pay more attention to the key object. The virtual prompt element corresponding to the key object may be a virtual template element designed in advance. For example, a virtual prompt element corresponding to a lane guide sign may be a virtual arrow, a virtual prompt element corresponding to a lane line sign may be a virtual lane line, a virtual prompt element corresponding to a vehicle may be a virtual vehicle designed in advance or a virtual element configured for representing a distance between the target vehicle and the vehicle, or a virtual prompt element corresponding to a pedestrian may be a virtual pedestrian designed in advance or a virtual element configured for representing a distance between the target vehicle and the pedestrian. The virtual prompt element corresponding to the key object may be further a virtual element generated in real time based on an actual key object in the driving environment. The virtual prompt element can reflect features possessed by the key object to some extent. No limitation is imposed on a representation form of the virtual prompt element corresponding to the key object herein in the present disclosure.

In this embodiment of the present disclosure, to enhance conformity of the virtual prompt element and a real driving environment to bring a more realistic information prompt effect for the driver, the display position of the virtual prompt element in the information display area corresponds to the position of the key object in the driving environment. To be specific, from a perspective of the driver, the virtual prompt element in the information display area overlaps the key object corresponding to the virtual prompt element, or a distance between the virtual prompt element and the key object corresponding to the virtual prompt element is less than a preset distance threshold (for example, 5 cm). For example, when the key object is a lane guide sign at an intersection, from the perspective of the driver, a virtual prompt element corresponding to the lane guide sign overlaps and is presented above the actual lane guide sign. For another example, when the key object is a vehicle on the road surface, from the perspective of the driver, a virtual prompt element corresponding to the vehicle overlaps and is presented above the actual vehicle. A specific implementation of determining the display position of the virtual prompt element conforming to the key object is also to be described in detail in another method embodiment below.

In some embodiments, in addition to the virtual prompt element generated based on the AR technology, the information display area may further include driving assistance information on a central control screen of the target vehicle, for example, a speed per hour of the target vehicle, a remaining fuel quantity, a remaining battery capacity, an engine revolution speed, and navigation information. No limitation is imposed on content displayed in the information display area herein in the present disclosure.

In some embodiments, if the driving environment where the target vehicle is located does not include the key object to which the driver needs to pay attention, the information display area may correspondingly not include the virtual prompt element corresponding to the key object.

FIG. 4 is a schematic diagram of an exemplary information display area according to an embodiment of the present disclosure. As shown in FIG. 4, an information display area 420 is displayed through a front windshield 410 of a target vehicle. The information display area 420 includes a virtual prompt element 421 corresponding to a lane guide sign actually existing on a road surface. From a perspective of a driver, the virtual prompt element 421 is displayed on the lane guide sign in an overlapping manner. In addition, the information display area 420 further includes a current speed per hour of 47 km/h of the target vehicle. Content without reference numerals in FIG. 4 is background content in the driving environment where the target vehicle is located, rather than content in the information display area generated through projection of an AR HUD device.

Operation 202: Change a position of the information display area on the front windshield in response to a change of the key object meeting a preset condition, so that the information display area includes a virtual prompt element corresponding to the key object that is changed.

When the key object in the driving environment has the change that meets the preset condition, the AR HUD device may change a position of imaging through projection thereof, i.e., change a position of a target imaging area on an imaging plane thereof, thereby correspondingly changing the position of the information display area on the front windshield of the target vehicle, so that the virtual prompt element corresponding to the key object that is changed may be completely accommodated in the target imaging area of which the position is changed, i.e., the virtual prompt element corresponding to the key object that is changed may be completely accommodated in the information display area of which the display position is changed.

The foregoing preset condition is a preset condition configured for determining whether the display position of the information display area needs to be changed. The preset condition may be, for example, that the key object that is changed exceeds or does not completely belong to an FOV to which the AR HUD device currently pays attention. The FOV to which the AR HUD device currently pays attention may be understood as an FOV corresponding to the information display area. If the key object that is changed exceeds or does not completely belong to the FOV to which the AR HUD device currently pays attention, the virtual prompt element corresponding to the key object that is changed cannot be displayed or cannot be completely displayed in the information display area. Therefore, the display position of the information display area needs to be adjusted, so that the virtual prompt element corresponding to the key object that is changed can be completely displayed in the information display area.

The foregoing change in the key object may specifically be a change in the key object to which the driver needs to pay attention, i.e., a change from a key object to another key object. For example, when the target vehicle is in a normal forward-moving state, a key object to which the driver originally needs to pay attention is a traffic sign on the road surface. If another vehicle or pedestrian suddenly appears in front of the target vehicle at this point, the key object to which the driver needs to pay attention is changed to the vehicle or the pedestrian that appeared. The foregoing change in the key object may specifically be a change in a position of the key object, i.e., the key object moves from a position to another position. For example, when the target vehicle follows a specific target, a position of the specific target relative to the target vehicle changes.

In one embodiment, the position of the information display area on the front windshield is changed if the key object changes from a first key object to a second key object and a virtual prompt element corresponding to the second key object in the information display area does not meet a first target display condition, so that the virtual prompt element corresponding to the second key object in the information display area meets the first target display condition.

Exemplarily, during traveling of the target vehicle, the key object to which the driver needs to pay attention may change, i.e., change to the second key object from the first key object to which attention is originally paid. If the virtual prompt element corresponding to the second key object in the target imaging area corresponding to the information display area on the imaging plane of the AR HUD device cannot meet a first target accommodation condition, i.e., the virtual prompt element corresponding to the second key object in the information display area cannot meet the first target display condition, the AR HUD device needs to adjust the position of the target imaging area thereof on the imaging plane, thereby achieving the adjustment of the position of the information display area on the front windshield. The virtual prompt element corresponding to the second key object in the target imaging area of which the position is adjusted can meet the first target accommodation condition, and the virtual prompt element corresponding to the second key object in the information display area of which the display position is adjusted can meet the first target display condition.

The foregoing first target display condition is a condition configured for determining whether the display of the virtual prompt element corresponding to the key object in the information display area meets a preset requirement, and the foregoing first target accommodation condition is a condition configured for determining whether the accommodation of the virtual prompt element corresponding to the key object in the target imaging area meets a preset requirement. Exemplarily, the first target display condition may be that the virtual prompt element corresponding to the key object is completely displayed in the information display area, and the first target accommodation condition may be that the virtual prompt element corresponding to the key object is completely accommodated in the target imaging area. Certainly, in an actual application, the foregoing first target display condition and the foregoing first target accommodation condition may also be set as other conditions based on an actual need. For example, the virtual prompt element corresponding to the key object is located in a specific display area in the information display area, and the virtual prompt element corresponding to the key object is located in a specific accommodating area in the target imaging area. No specific limitation is imposed on the foregoing first target display condition and the foregoing first target accommodation condition herein in the present disclosure.

In an actual application, if the key object to which the driver needs to pay attention changes from the first key object to the second key object, but the virtual prompt element corresponding to the second key object in the information display area still meets the first target display condition, the display position of the information display area does not need to be changed.

In an example, when the foregoing first key object is a target ground object and the foregoing second key object is a target overground object, the position of the information display area on the front windshield may be moved upward by changing the position of the information display area on the front windshield. When the foregoing first key object is the target overground object and the foregoing second key object is the target ground object, the position of the information display area on the front windshield may be moved downward by changing the position of the information display area on the front windshield. A position of the foregoing target ground object is lower than a position of the target overground object.

The target ground object may be an object on the road surface to which the driver needs to pay attention, for example, a traffic sign (a lane guide sign at an intersection or a lane line) drawn on the road surface, and for another example, a navigation sign displayed on the road surface through superimposition by the AR HUD device. The target overground object may be an object on the ground to which the driver needs to pay attention, for example, a vehicle, a pedestrian, or an obstacle warned by an advanced driving assistance system (ADAS).

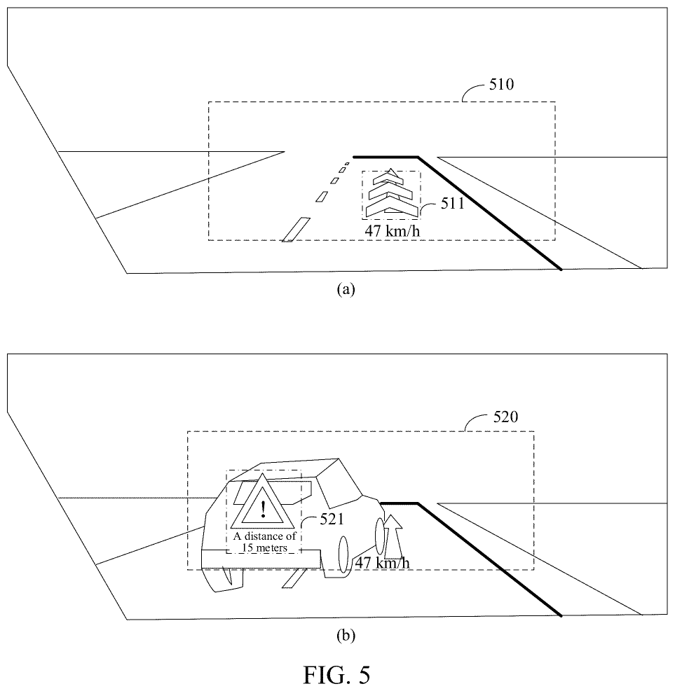

FIG. 5 is a schematic diagram of changing a display position of an information display area according to an embodiment of the present disclosure. As shown in (a) in FIG. 5, when a target vehicle is in a normal forward-moving state, a first key object to which attention is originally paid is a lane guide sign on a road surface. In this case, an information display area is an area 510 shown in (a) in FIG. 5, which includes a virtual prompt element (i.e., a virtual element 511) corresponding to the lane guide sign. If another vehicle suddenly cuts in front of the target vehicle and the vehicle triggers an ADAS warning of the target vehicle, the information display area is correspondingly moved upward to an area 520 shown in (b) in FIG. 5, which includes a virtual prompt element (i.e., a virtual element 521 prompting a distance between the target vehicle and the vehicle that triggers the ADAS warning) corresponding to the vehicle that triggers the ADAS warning. In addition, if a vehicle that triggers the ADAS warning exists in front of the target vehicle during the traveling of the target vehicle, in this case, the virtual prompt element corresponding to the vehicle that triggers the ADAS warning is displayed in the information display area. If navigation information indicates that the target vehicle is about to change a lane, the information display area is correspondingly moved downward, and a virtual prompt element corresponding to the navigation information is displayed in the information display area. From a perspective of the driver, the virtual prompt element is usually displayed on the road surface through superimposition. Content without reference numerals in FIG. 5 is background content in the driving environment where the target vehicle is located, rather than content in the information display area generated through projection of an AR HUD device.

In this way, in the foregoing manner, when the key object to which the driver needs to pay attention changes from the target ground object to the target overground object, or when the key object to which the driver needs to pay attention changes from the target overground object to the target ground object, the position of the information display area on the front windshield is flexibly adjusted in a vertical direction, so that the virtual prompt element corresponding to the key object that is changed is completely accommodated in the information display area of which the position is adjusted, thereby providing a better prompt for the driver, so that the driver may pay attention to the key object that is changed in a timely manner.

In another example, when the foregoing first key object is a target object on a left side of a line of sight and the foregoing second key object is a target object on a right side of the line of sight, the position of the information display area on the front windshield may be moved rightward by changing the position of the information display area on the front windshield. When the foregoing first key object is the target object on the right side of the line of sight and the foregoing second key object is the target object on the left side of the line of sight, the position of the information display area on the front windshield may be moving leftward by changing the position of the information display area on the front windshield.

The target object on the left side of the line of sight may be an object located on a left side of a line of sight of the driver and to which the driver needs to pay attention. The target object on the right side of the line of sight may be an object located on a right side of the line of sight of the driver and to which the driver needs to pay attention. The target object on the left side of the line of sight and the target object on the right side of the line of sight described above each include but are not limited to a traffic sign drawn on the road surface, a navigation sign displayed on the road surface through superimposition, and a vehicle, a pedestrian, and an obstacle on a road.

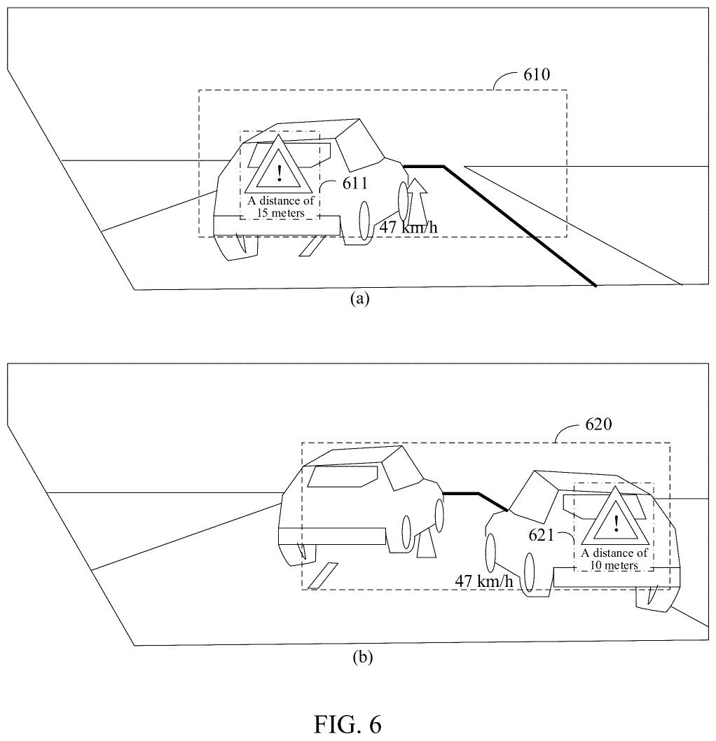

FIG. 6 is a schematic diagram of changing a display position of an information display area according to an embodiment of the present disclosure. As shown in (a) in FIG. 6, during traveling of a target vehicle, a first vehicle that triggers an ADAS warning of the target vehicle exists in left front of the target vehicle. In this case, an information display area is an area 610 shown in (a) in FIG. 6, which includes a virtual prompt element (i.e., a virtual element 611, prompting a distance between the target vehicle and the first vehicle) corresponding to the first vehicle. If a second vehicle that triggers the ADAS warning of the target vehicle suddenly appears in right front of the target vehicle, in this case, the information display area is correspondingly moved rightward to an area 620 shown in (b) in FIG. 6, which includes a virtual prompt element (i.e., a virtual element 621, prompting a distance between the target vehicle and the second vehicle) corresponding to the second vehicle. Similarly, if the key object to which the driver needs to pay attention changes from a third vehicle located in the right front to a fourth vehicle located in the left front, the information display area is correspondingly moved leftward, and a virtual prompt element corresponding to the fourth vehicle is displayed. Content without reference numerals in FIG. 6 is background content in the driving environment where the target vehicle is located, rather than content in the information display area generated through projection of an AR HUD device.

In this way, in the foregoing manner, when the key object to which the driver needs to pay attention changes from a target object on a left side of a line of sight to a target object on a right side of the line of sight, or when the key object to which the driver needs to pay attention changes from the target object on the right side of the line of sight to the target object on the left side of the line of sight, the position of the information display area on the front windshield is flexibly adjusted in a horizontal direction, so that a virtual prompt element corresponding to the key object that is changed is completely accommodated in the information display area of which the position is adjusted, thereby providing a better prompt for the driver, so that the driver may pay attention to the key object that is changed in a timely manner.

In an actual application, movement directions of the display position of the information display area are not limited to those described above, i.e., upward, downward, leftward, and rightward, or may be upper left, lower left, upper right, lower right, or the like based on an actual need. No limitation is imposed on the movement directions of the display position of the information display area herein in the present disclosure.

In addition, the movement directions and the movement distance of the information display area in the foregoing examples may specifically be determined by imaging positions of virtual prompt elements respectively corresponding to a first key object and a second key object on an imaging plane of the AR HUD device. To be specific, a first imaging position of the virtual prompt element corresponding to the first key object on the imaging plane may be determined, and a second imaging position of the virtual prompt element corresponding to the second key object on the imaging plane may be determined. The imaging plane is a virtual image imaging plane generated through the projection of the AR HUD device. Then the display position of the information display area is changed based on a positional relationship between the first imaging position and the second imaging position.

Specifically, when the key object to which the driver needs to pay attention changes from the first key object to the second key object, the first imaging position of the virtual prompt element corresponding to the first key object on the imaging plane of the AR HUD device may be determined based on a position of the first key object in an actual driving environment, and the second imaging position of the virtual prompt element corresponding to the second key object on the imaging plane of the AR HUD device may be determined based on a position of the second key object in the actual driving environment. A specific implementation of determining the imaging position corresponding to the virtual prompt element corresponding to the key object on the imaging plane is to be described in detail in another method embodiment below. Then a movement manner of a target imaging area corresponding to the information display area on the imaging plane is determined based on the positional relationship between the first imaging position and the second imaging position. The target imaging area is moved based on the movement manner, so that the virtual prompt element corresponding to the second key object in the target imaging area meets a first target accommodation condition. Then movement of the AR HUD device is controlled based on the determined movement manner of the target imaging area, so that the target imaging area may be moved based on the determined movement manner. The movement of the target imaging area results in a change in the display position of the information display area, and the virtual prompt element corresponding to the second key object in the information display area of which the display position is changed can meet a first target display condition.

In this way, in the foregoing manner, when the key object to which the driver needs to pay attention changes from a key object to another key object, the display position of the information display area generated through the projection of the AR HUD device may be flexibly and accurately adjusted, so that the virtual prompt element corresponding to the key object that is changed may be completely accommodated in the information display area, thereby attracting the driver to pay attention to the key object that is changed.

In another embodiment, the position of the information display area on the front windshield is changed if the position of the key object in the driving environment changes from a first position to a second position and a virtual prompt element corresponding to the key object in the information display area does not meet a second target display condition when the key object is in the second position, so that the virtual prompt element corresponding to the key object in the information display area meets the second target display condition when the key object is in the second position.

Exemplarily, during the traveling of the target vehicle, a position of the key object to which the driver needs to pay attention relative to the target vehicle may change, i.e., a position relative to the target vehicle may change from the first position to the second position. For example, assuming that the key object to which the driver pays attention is a reference vehicle traveling in front of the driver, sudden acceleration of the reference vehicle may cause a distance between the reference vehicle and the target vehicle to rapidly increase, sudden deceleration of the reference vehicle may cause the distance between the reference vehicle and the target vehicle to rapidly decrease, and sudden leftward or rightward movement of the reference vehicle may cause a change in a relative orientation between the reference vehicle and the target vehicle. Alternatively, sudden acceleration of the target vehicle may cause the distance between the target vehicle and the reference vehicle to rapidly decrease, sudden deceleration of the target vehicle may cause the distance between the target vehicle and the reference vehicle to rapidly increase, sudden leftward or rightward movement of the target vehicle may cause a change in the relative orientation between the target vehicle and the reference vehicle, or the like.

If the virtual prompt element corresponding to the key object in the second position in the target imaging area corresponding to the information display area on the imaging plane of the AR HUD device cannot meet a second target accommodation condition, i.e., the virtual prompt element corresponding to the key object in the second position in the information display area cannot meet the second target display condition, the AR HUD device needs to adjust the position of the target imaging area thereof on the imaging plane, thereby achieving the adjustment of the position of the information display area on the front windshield. The virtual prompt element corresponding to the second key object in the second position in the target imaging area of which the position is adjusted can meet the second target accommodation condition, and the virtual prompt element corresponding to the key object in the second position in the information display area of which the position is adjusted can meet the second target display condition.

The foregoing second target display condition is a condition configured for determining whether the display of the virtual prompt element corresponding to the key object in the information display area meets a preset requirement, and the foregoing second target accommodation condition is a condition configured for determining whether the accommodation of the virtual prompt element corresponding to the key object in the target imaging area meets a preset requirement. Exemplarily, the second target display condition may be that the virtual prompt element corresponding to the key object is completely displayed in the information display area, and the second target accommodation condition may be that the virtual prompt element corresponding to the key object is completely accommodated in the target imaging area. Certainly, in an actual application, the foregoing second target display condition and the foregoing second target accommodation condition may also be set as other conditions based on an actual need. No specific limitation is imposed on the foregoing second target display condition and the foregoing second target accommodation condition herein in the present disclosure.

In an actual application, if the position of the key object to which the driver needs to pay attention in the driving environment changes from the first position to the second position, but the virtual prompt element corresponding to the key object in the information display area still meets the second target display condition, the display position of the information display area does not need to be changed.

The changing manner of the display position of the information display area in this implementation may specifically be determined by the imaging positions of the virtual prompt elements respectively corresponding to the key object in the first position and the key object in the second position on the imaging plane of the AR HUD device. To be specific, a third imaging position of a virtual prompt element corresponding to the key object on the imaging plane when the key object is in the first position may be determined, and a fourth imaging position of a virtual prompt element corresponding to the key object on the imaging plane when the key object is in the second position may be determined, the imaging plane being a virtual image imaging plane generated through the projection of the AR HUD device; and then the position of the information display area on the front windshield being changed based on a positional relationship between the third imaging position and the fourth imaging position.

Specifically, when the position of the key object to which the driver pays attention in the driving environment changes from the first position to the second position, the third imaging position of the virtual prompt element corresponding to the key object in the first position on the imaging plane of the AR HUD device may be determined based on the first position, and the fourth imaging position of the virtual prompt element corresponding to the key object in the second position on the imaging plane of the AR HUD device may be determined based on the second position. A specific implementation of determining the imaging position of the virtual prompt element corresponding to the key object on the imaging plane is to be described in detail in another method embodiment below. Then a movement manner of a target imaging area corresponding to the information display area on the imaging plane is determined based on the positional relationship between the third imaging position and the fourth imaging position. The target imaging area is moved based on the movement manner, so that the virtual prompt element corresponding to the key object in the second position in the target imaging area meets the second target accommodation condition. Then movement of the AR HUD device is controlled based on the determined movement manner of the target imaging area, so that the target imaging area may be moved based on the determined movement manner. The movement of the target imaging area results in a change in the display position of the information display area, and the virtual prompt element corresponding to the key object in the second position in the information display area of which the display position is changed can meet the second target display condition.

In this way, in the foregoing manner, when the position of the key object to which the driver pays attention changes from the first position to the second position, the display position of the information display area generated through the projection of the AR HUD device may be flexibly and accurately adjusted, so that the virtual prompt element corresponding to the key object of which the position is changed may be completely displayed in the information display area, to facilitate continuous attention to the key object by the driver.

In some embodiments, the driving environment may include a plurality of basic key objects to which the driver needs to pay attention, but the virtual prompt element corresponding to each of the plurality of basic key objects in the information display area due to a limited FOV corresponding to the information display area does not meet a third target display condition. In this case, a primary key object and a secondary key object may be distinguished among the plurality of basic key objects, a virtual prompt element corresponding to the primary key object is displayed in the information display area, and prompt content corresponding to the secondary key object is displayed based on a preset prompt manner.

The basic key object is an object to which the driver needs to pay attention in the driving environment, or may be referred to as an object of interest. The basic key object may specifically be obtained through image detection of an image captured by a front camera of the target vehicle. To be specific, the image captured by the front camera of the target vehicle may be detected by using an image detection model, to obtain an object of a preset type as the basic key object. The object of the preset type herein is a preset type of the object to which the driver needs to pay attention in the driving environment.

The primary key object is an object with a relatively high importance level among the basic key objects, and the secondary key object is an object with a relatively low importance level among the basic key objects. An importance level of the basic key object may be determined through a type of the basic key object and/or a distance between the basic key object and the target vehicle.

Exemplarily, the importance level corresponding to each determined basic key object may be determined based on a state of the target vehicle. For example, the importance level corresponding to the basic key object may be determined based on the type of the basic key object and/or the distance between the basic key object and the target vehicle. Then the basic key objects are arranged in descending order of importance levels, then first k (k is an integer greater than or equal to 1) basic key objects are used as the primary key objects, and the remaining basic key objects are used as the secondary key objects.

More specifically, importance level classification rules respectively corresponding to a plurality of driving states (including but not limited to a forward-moving state, a lane changing state, a state at an intersection, and the like) may be preset. Each of the importance level classification rules is configured for specifying a correspondence between the type of the basic key object and the importance level in the corresponding driving state. For example, assuming that the importance level classification rule corresponding to the forward-moving state indicates that for a basic key object at a distance from the target vehicle less than a preset distance threshold, a basic key object of a pedestrian type has a highest importance level, a basic key object of a vehicle type has a second highest importance level, and a basic key object of a road sign type has a lowest importance level. Correspondingly, if a current driving environment includes all of the three basic key objects including a pedestrian, a vehicle, and a road sign, it may be determined that the pedestrian has the highest importance level, the vehicle has the secondary importance level, and the road sign has the lowest importance level. Correspondingly, the pedestrian may be used as the primary key object, and the vehicle and the road sign may be used as the secondary key objects.

Exemplarily, it is assumed that two basic key objects to which the driver needs to pay attention exist in the driving environment where the target vehicle is located, namely a lane guide sign and a reference vehicle that triggers the ADAS warning, and both a virtual prompt element corresponding to the lane guide sign and a virtual prompt element corresponding to the reference vehicle in the information display area cannot meet the third target display condition. In this case, the primary key object and the secondary key object need to be determined from the two basic key objects based on a preset key object importance level classification rule and a current state of the target vehicle. For example, when the target vehicle is in an intersection guide state, the lane guide sign may be determined as the primary key object, and the reference vehicle may be determined as the secondary key object. For another example, when the target vehicle is in a normal forward-moving state, the reference vehicle may be determined as the primary key object, and the lane guide sign may be determined as the secondary key object. Certainly, in an actual application, more basic key objects may exist in the driving environment where the target vehicle is located, and a quantity of primary key objects and a quantity of secondary key objects each are not limited to only one.

The foregoing third target display condition is a condition configured for determining whether the display of the virtual prompt element corresponding to the basic key object in the information display area meets a preset requirement. Exemplarily, the third target display condition may be that the virtual prompt element corresponding to the basic key object is completely displayed in the information display area. Certainly, in an actual application, the foregoing third target display condition may also be set as another condition based on an actual need. The foregoing third target display condition is not specifically limited herein in the present disclosure.

Then the display position of the information display area is determined based on the imaging position of the virtual prompt element corresponding to the primary key object on the imaging plane, and the virtual prompt element corresponding to the primary key object is displayed in the information display area. Since the driver also needs to pay attention to the secondary key object, the corresponding prompt content may be displayed in the information display area based on the preset prompt manner. For example, a prompt identifier or a prompt text corresponding to the secondary key object may be displayed in the information display area.

In an example, the prompt content corresponding to the secondary key object may be displayed based on a target edge area of the information display area, a relative direction between the target edge area and a center of the information display area matching a relative direction between the secondary key object and the target vehicle in the driving environment.

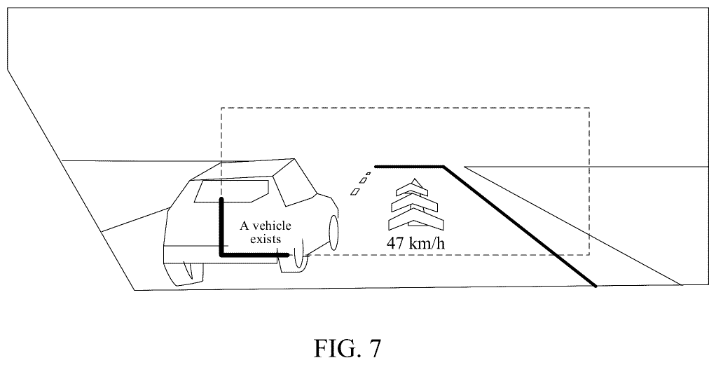

FIG. 7 is a schematic diagram of an information display area according to an embodiment of the present disclosure. As shown in FIG. 7, assuming that a secondary key object is a reference vehicle located in the left front of a target vehicle, and a distance between the reference vehicle and the target vehicle is relatively small, existence of the reference vehicle may be prompted through a lower left edge area of the information display area. For example, the existence of the reference vehicle may be prompted through marking the lower left edge area in red, or a prompt identifier or a prompt text corresponding to the reference vehicle may be displayed in the lower left edge area of the information display area.

The foregoing target edge area may be determined based on the relative direction between the secondary key object and the target vehicle, which may specifically be at least one of a left edge area, a right edge area, an upper edge area, a lower edge area, a lower left edge area, an upper left edge area, a lower right edge area, and an upper right edge area. A position of the target edge area is not limited herein in the present disclosure.

In this way, in the foregoing manner, in a case that the driver needs to pay attention to a plurality of key objects simultaneously, but a virtual prompt element corresponding to each of the plurality of key objects cannot be completely displayed simultaneously in the information display area, simultaneous prompting of the plurality of key objects may be realized. Moreover, through the distinguishing between a primary key object and the secondary key object and prompting of the primary key object and the secondary key object in different manners, the driver may selectively pay attention to the plurality of key objects to different degrees. For example, the primary key object is prompted through a virtual prompt element, and the secondary key object is prompted through the target edge area of the information display area, so that the driver may pay attention to the primary key object in priority and then pay attention to the secondary key object, which facilitate improvement in driving safety.

According to the information display method provided in the embodiments of the present disclosure, a position of an FOV for imaging of the AR HUD device may be dynamically adjusted based on a change of the key object in the driving environment where the target vehicle is located. In other words, the position of the information display area generated through the projection of the AR HUD device and through the front windshield of the target vehicle on the front windshield may be dynamically adjusted, so that the virtual prompt element corresponding to the key object in the driving environment may be continuously displayed in the information display area, and it is ensured that the display position of the virtual prompt element corresponds to the position of the key object in the driving environment, to provide more realistic prompt information for a driver. According to the information display method provided in the embodiments of the present disclosure, when the key object changes to another FOV from an FOV to which the AR HUD device currently pays attention, the AR HUD device may adjust the position of the information display area generated through the projection thereof on the front windshield, so that the information display area corresponds to the changed FOV. In this way, the information prompted by the AR HUD device is no longer limited to a specific FOV, and may dynamically correspond to a wider FOV. Correspondingly, the driver may learn richer prompt information through the dynamic information display area, thereby improving usage experience.

A manner of determining the display position of the foregoing information display area is described in detail through a method embodiment below. In this embodiment, a manner of determining the key object, a manner of determining the position of the key object in the driving environment, and a manner of determining the imaging position of the key object on the imaging plane of the AR HUD device in the above are also described.

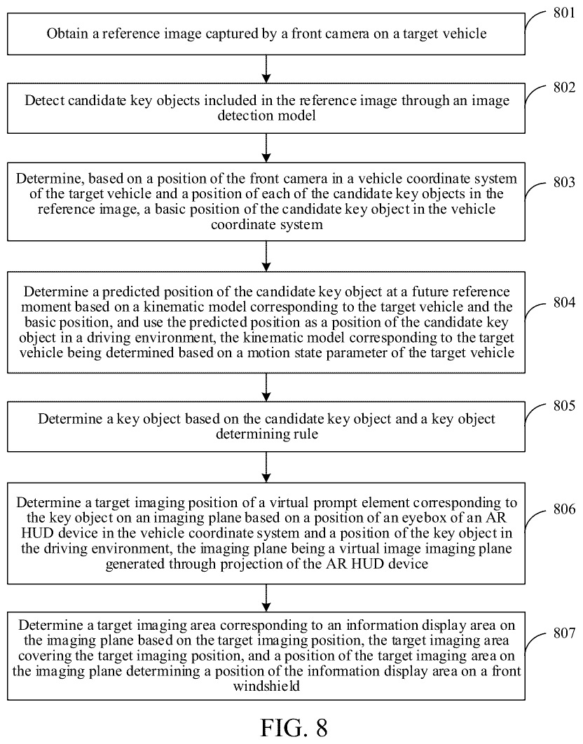

FIG. 8 is a schematic flowchart of a method for determining a display position of an information display area according to an embodiment of the present disclosure. The method for determining the display position is performed by an electronic device on a target vehicle configured to control an AR HUD device. As shown in FIG. 8, the method for determining the display position includes the following operations.

Operation 801: Obtain a reference image captured by a front camera on a target vehicle.

In this embodiment of the present disclosure, the front camera on the target vehicle may capture, at a specific frame rate (for example, 30 frames per second), the reference image corresponding to an FOV of a driver in a driving environment where the target vehicle is located, namely a reference image configured to reflect a driving environment in front of the target vehicle. The front camera herein refers to a camera mounted to the target vehicle and configured to capture an image of the environment in front of the target vehicle, which may specifically be a driving recorder.

Then the front camera may transmit the reference image captured by the front camera to the electronic device configured to control the AR HUD device, so that the electronic device determines, based on the received reference image, the key object to which the driver needs to pay attention in the driving environment and a position of the key object.

Operation 802: Detect a candidate key object included in the reference image through an image detection model.

After receiving the reference image transmitted by the front camera, the electronic device may input the reference image into a pre-trained image detection model. The image detection model may output a corresponding detection result through analysis of the inputted reference image. The detection result includes a position of the candidate key object in the reference image and a type of the candidate key object.

The foregoing image detection model may be any deep neural network model that can detect a specific target in the inputted image and a position of the specific target in the inputted image. The image detection model may be, for example, a region-convolutional neural network (R-CNN) model, or a region-based fully convolutional network (R-FCN) model. No limitation is imposed on a model structure of the image detection model herein in the present disclosure. The foregoing candidate key object may be understood as an object of a preset type in the driving environment, for example, a traffic sign, a vehicle, or a pedestrian.

Exemplarily, in this embodiment of the present disclosure, a traffic sign (including but not limited to a lane guide sign, a lane line, or the like on a road surface), a vehicle, and a pedestrian in the reference image may be detected by using the image detection model. To be specific, after the electronic device inputs the reference image transmitted from the front camera into the image detection model, the image detection model may correspondingly detect whether the traffic sign, the vehicle, and the pedestrian exist in the reference image. If the traffic sign, the vehicle, and the pedestrian exist, a position of the traffic sign, a position of the vehicle, and a position of the pedestrian are indicated in the reference image. For other information in the driving environment to which the driver does not need to pay special attention, the image detection model may not need to perform the detection.

In this way, in the foregoing manner, the reference image captured by the front camera on the target vehicle is detected by using the image detection model, and the object of the preset type is determined as the candidate key object, so that the object to which the driver may need to pay attention in a driving environment where the target vehicle is currently located may be accurately identified, and a key object to which the driver really needs to be pay attention is further determined from the candidate key object. In this way, it may be ensured that the determined key object has relatively high importance and is a real object that exists in a driving environment where the target vehicle is actually located. Correspondingly, the existence of the key object is prompted through a virtual prompt element, so that driving safety may be improved more effectively.

Operation 803: Determine, based on a position of the front camera in a vehicle coordinate system of the target vehicle and a position of the candidate key object in the reference image, a basic position of the candidate key object in the vehicle coordinate system.

After determining the candidate key object included in the reference image through the image detection model, the electronic device may further determine the basic position of each candidate key object in the vehicle coordinate system of the target vehicle based on a position of the candidate key object in an image coordinate system of the reference image, to achieve switching of position information of the candidate key objects between the image coordinate system and the vehicle coordinate system.

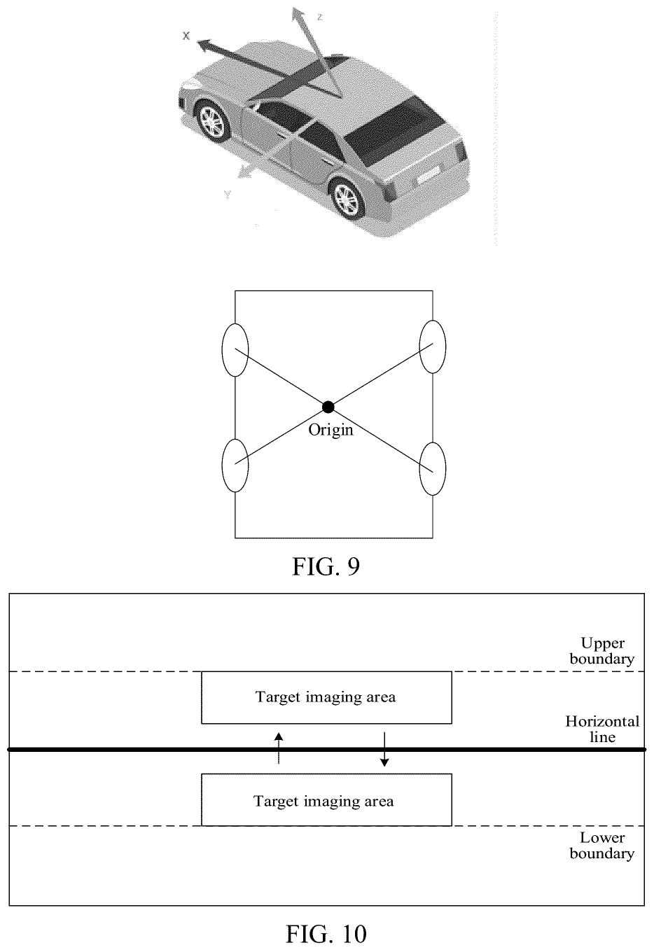

Specifically, the position of the front camera in the vehicle coordinate system of the target vehicle may be pre-calibrated. FIG. 9 is a schematic diagram of a vehicle coordinate system of a target vehicle. The vehicle coordinate system uses an intersection point of diagonal lines of four wheels of a chassis of the target vehicle as an origin, uses a direction from the origin to front of the target vehicle as an x-axis, uses a direction from the origin to right of the target vehicle as a y-axis, and uses a direction from the origin to a top of the target vehicle as a z-axis. Then the position of the front camera in the vehicle coordinate system may be calibrated offline based on the vehicle coordinate system. To be specific, an x coordinate, a y coordinate, and a z coordinate (all in meter) of the front camera in the vehicle coordinate system, as well as a pitch angle, a yaw angle, and a roll angle of the front camera are calibrated. In addition, an intrinsic parameter of the front camera further needs to be calibrated offline. The foregoing calibration is usually completed before the target vehicle leaves a factory.

In a case that a position of a candidate key object in the image coordinate system of the reference image, the position of the front camera capturing the reference image in the vehicle coordinate system, and the intrinsic parameter of the front camera are known, the electronic device may determine the basic position of the candidate key object in the vehicle coordinate system of the target vehicle through spatial position conversion calculation.

Operation 804: Determine a predicted position of the candidate key object at a future reference moment based on a kinematic model corresponding to the target vehicle and the basic position, and use the predicted position as the position of the candidate key object in the driving environment, the kinematic model corresponding to the target vehicle being determined based on a motion state parameter of the target vehicle.

A main function of the information display area generated through projection of an AR HUD device is to convey warning information to a driver. To ensure timeliness of the warning, prompt content displayed in the information display area is usually predicted based on historical information. For example, warning prompt content displayed in the information display area at a moment t is usually predicted based on historical information collected at a moment t−1 or even an earlier moment, rather than determined based on information collected at the moment t. Based on this, for each candidate key object in the reference image, the electronic device needs to predict a predicted position of the candidate key object at the future reference moment based on a motion state corresponding to the target vehicle and the basic position of the candidate key object, uses the predicted position as the position of the candidate key object in the driving environment mentioned above, and accordingly determines the display position of the corresponding virtual prompt element in the information display area.

Specifically, the electronic device may obtain a motion state parameter of the target vehicle collected by a sensor on the target vehicle, for example, a vehicle speed, a steering wheel angle, inertial measurement unit (IMU) data, an image captured by a camera, or a radar parameter. The IMU data may include an acceleration, a rotation speed, and the like of the target vehicle. Then the electronic device may establish the kinematic model corresponding to the target vehicle based on an establishment algorithm (for example, a visual inertial odometry (VIO) algorithm) of a vehicle kinematic model by using the foregoing motion state parameter. The kinematic model may reflect a current motion state of the target vehicle, and estimate a future motion state of the target vehicle, for example, a position and an orientation at a specific moment in the future. The electronic device may correspondingly predict the predicted position of the candidate key object at the future reference moment (i.e., a specific moment in the future, such as n seconds (n is greater than 0) after a current moment) based on the kinematic model of the target vehicle and the basic position of the candidate key object in the vehicle coordinate system. The predicted position is also a position in the vehicle coordinate system. Then the predicted position is used as the position of the candidate key object in the driving environment where the target vehicle is located, and the position may be subsequently configured for determining whether the candidate key object is the key object to which the driver needs to pay attention and configured for determining an imaging position of the corresponding virtual prompt element.

The foregoing operation of determining the predicted position of the candidate key object may be implemented by a tracker in the electronic device. To be specific, each candidate key object in the reference image may be inputted into the tracker, and the tracker may automatically determine a predicted position of each candidate key object at a specific moment in the future based on the kinematic model corresponding to the target vehicle.

In this way, in the foregoing manner, the predicted position of the key object at the future moment is determined based on the kinematic model corresponding to the target vehicle, so as to ensure accuracy of the predicted position of the determined key object. Correspondingly, the predicted position is subsequently used as the position of the key object in the driving environment, and the position of the virtual prompt element corresponding to the key object in the information prompt area is determined accordingly, so as to ensure that the virtual prompt element accurately corresponds to the position of the key object in the actual driving environment.

Operation 805: Determine a key object based on the candidate key objects and a key object determining rule.

Then electronic device may select the key object to which the driver needs to pay attention from the candidate key objects based on a preset key object determining rule and the position of each candidate key object in the driving environment, and display the virtual prompt element corresponding to the key object through projection of the information display area generated through the projection of the AR HUD device in the subsequent operation, to prompt the driver to pay attention to the key object.

In one embodiment, the electronic device may determine the key object based on a current driving state of the target vehicle by: determining an obstacle object at a distance to the target vehicle less than a preset distance threshold as the key object when the target vehicle is in a normal forward-moving state and if the candidate key objects include the obstacle object; determining lane change prompt information attached to a road surface as the key object when the target vehicle is in a pre-lane change state; and determining a lane guide sign for an intersection as the key object when the target vehicle is in a pre-intersection arrival state and if the candidate key objects include the lane guide sign.

Exemplarily, warning prompt information provided by the AR HUD device may be classified into two categories: guide prompt information (which is configured for guiding a forward direction of the target vehicle), and warning prompt information (which is configured for prompting existence of an obstacle element in the driving environment). The guide prompt information usually corresponds to the following three states: a normal forward-moving state (i.e., a state in which the vehicle moves forward normally), a pre-lane change state (i.e., a state in which the vehicle is about to change a lane), and a pre-intersection arrival state (i.e., a state in which the vehicle is about to arrive at an intersection). The warning prompt information usually corresponds to the following two cases: a warning for a front vehicle and a warning for a pedestrian.

This embodiment of the present disclosure provides, based on the classification of the foregoing warning prompt information, an exemplary key object determining rule for determining the key object to which the driver needs to pay attention. To be specific, when the target vehicle is in the normal forward-moving state, if existence of a candidate key object that may trigger an ADAS warning is detected based on the position of each candidate key object in the driving environment, the candidate key object that may trigger the ADAS warning is used as the key object to which the driver needs to pay attention. For example, a vehicle or a pedestrian that may trigger the ADAS warning is used as the key object. When the target vehicle is in the pre-lane change state, lane change prompt information indicated by navigation information may be used as the key object. When the target vehicle is in the pre-intersection arrival state, the lane guide sign at the intersection may be used as the key object.

The foregoing key object determining rule is merely an example. In an actual application, the key object to which the driver needs to pay attention may also be determined based on another key object determining rule. No limitation is imposed on the key object determining rule herein in the present disclosure.

In this way, in the foregoing manner, the key object to which the driver needs to pay attention is determined from the candidate key objects based on the current driving state of the target vehicle and based on factors such as a type of each candidate key object and a distance between each candidate key object and the target vehicle, so as to ensure that the determined key object is a key object to which the driver currently needs to pay most attention. Correspondingly, the virtual prompt element corresponding to the key object is displayed in the information display area, so as to provide a better prompt, and facilitate improvement of driving safety.

Operation 806: Determine a target imaging position of the virtual prompt element corresponding to the key object on the imaging plane based on a position of an eyebox of the AR HUD device in the vehicle coordinate system and the position of the key object in the driving environment, the imaging plane being a virtual image imaging plane generated through the projection of the AR HUD device; and

After determining the key object to which the driver needs to pay attention and the position of the key object in the driving environment, the electronic device may determine the target imaging position of the virtual prompt element corresponding to the key object on the imaging plane (a virtual image imaging plane) of the AR HUD device based on the position of the eyebox of the AR HUD device in the vehicle coordinate system of the target vehicle and the position of the key object in the driving environment.

The eyebox of the AR HUD device refers to a movable area of eyes of the driver. Generally, factors such as a height, a sitting posture, and a head position of the driver affect a position of the eyes of the driver and a direction of a line of sight, resulting in a change in a driving perspective. When the eyes of the driver are in the eyebox of the AR HUD device, the information display area generated through the projection of the AR HUD device may be clearly and completely seen. In this embodiment of the present disclosure, the position of the eyebox of the AR HUD device in the vehicle coordinate system of the target vehicle may be calibrated before the target vehicle leaves the factory. The vehicle coordinate system of the target vehicle is shown in FIG. 9. An x coordinate, a y coordinate, and a z coordinate (all in meter) of the eyebox in the vehicle coordinate system, as well as a pitch angle, a yaw angle, and a roll angle of the eyebox may be calibrated offline based on the vehicle coordinate system. In addition, the intrinsic parameter for the projection of the AR HUD device further needs to be calibrated offline.

In a case that the position of the key object in the vehicle coordinate system (the position of the key object in the driving environment is essentially a predicted position of the key object in the vehicle coordinate system), the position of the eyebox of the AR HUD device in the vehicle coordinate system, and the intrinsic parameter for the projection of the AR HUD device are known, the electronic device may determine the target imaging position of the virtual prompt element corresponding to the key object on the virtual image imaging plane of the AR HUD device through the spatial position conversion calculation.

Since the position of the front camera, the position of the eyebox of the AR HUD device, and the position of the key object described above are all determined based on the vehicle coordinate system of the target vehicle, accuracy of the target imaging position of the virtual prompt element corresponding to the determined key object on the imaging plane may be effectively ensured, i.e., it is ensured that the display position corresponding to the target imaging position in the information display area may accurately conform to the key object in the real driving environment.

Operation 807: Determine a target imaging area corresponding to the information display area on the imaging plane based on the target imaging position, the target imaging area covering the target imaging position, and a position of the target imaging area on the imaging plane determining the position of the information display area on the front windshield.

After the target imaging position of the virtual prompt element corresponding to the key object on the imaging plane of the AR HUD device is determined, the corresponding target imaging area of the information display area generated through projection of the AR HUD device on the imaging plane may be correspondingly determined based on the target imaging position. Specifically, the position of the target imaging area may be determined based on a principle that the target imaging area completely covers the target imaging position.

The determining of the target imaging area on the imaging plane represents the determining of the display position of the information display area corresponding to the target imaging area, and the determining of the target imaging position on the imaging plane represents the determining of the display position of the virtual prompt element corresponding to the target imaging position. To be specific, the target imaging area and the target imaging position on the imaging plane may be correspondingly projected as the information display area and the virtual prompt element based on a light reflection principle.

As described in the embodiment shown in FIG. 2, the key object may change during the traveling of the target vehicle. When the change of the key object is a change from a key object to another key object, the electronic device may detect the change through the foregoing operation 801 to operation 805. In this case, the electronic device may determine a target imaging position of a virtual prompt element corresponding to a new key object on the imaging plane by performing operation 806, then determine, based on a positional relationship between the target imaging position and an original target imaging area, whether operation 807 needs to be performed to adjust the position of the target imaging area, and need to perform operation 807 to re-determine the position of the target imaging area if the target imaging position has exceeded the target imaging area, so that the target imaging area completely covers the target imaging position. Through the adjustment of the position of the target imaging area, the adjustment of the display position of the information display area may be realized. When the change of the key object is a change relative to the position of the target vehicle, the electronic device may determine the target imaging position of the virtual prompt element corresponding to the key object on the imaging plane through the foregoing operation 801 to operation 806, then determine, based on the positional relationship between the target imaging position and the original target imaging area, whether operation 807 needs to be performed to adjust the position of the target imaging area, and need to perform operation 807 to re-determine the position of the target imaging area if the target imaging position has exceeded the target imaging area, so that the target imaging area completely covers the target imaging position. Through the adjustment of the position of the target imaging area, the adjustment of the display position of the information display area may be realized.

In an actual application, to prevent the information display area from exceeding an FOV of the driver or the driver from being unable to completely see the information display area as a result of the adjustment of the display position of the information display area, a corresponding movable range may be set for the target imaging area, to control the target imaging area to move only within the movable range.

FIG. 10 is a schematic diagram of a movable range of a target imaging area according to an embodiment of the present disclosure. As shown in FIG. 10, for an imaging plane, all parallel lines (such as lane lines) on the ground intersect with a line on a horizon. The line is usually referred to as a horizontal line. In this embodiment of the present disclosure, an upper boundary and a lower boundary of the movable range may be determined based on an imaging position corresponding to the horizontal line on the imaging plane. For example, an imaging position corresponding to a position at N meters in front of a target vehicle on the imaging plane may be defined as the lower boundary, and an imaging position corresponding to a position at M meters in front of the target vehicle on the imaging plane may be defined as the upper boundary. N is less than a distance between the horizontal line and the target vehicle, and M is greater than the distance between the horizontal line and the target vehicle. In addition, in this embodiment of the present disclosure, a left boundary and a right boundary of the movable range may also be defined based on an actual need. An area of the movable range is not specifically limited herein in the present disclosure.

According to the method for determining the display position of the information display area provided in the embodiments of the present disclosure, the position of the front camera of the target vehicle and the position the eyebox of the AR HUD device in the vehicle coordinate system of the target vehicle are determined offline, then the position of the key object in the reference image captured by the front camera is mapped to the vehicle coordinate system based on the vehicle coordinate system, and then the position of the key object in the vehicle coordinate system is mapped to a projection imaging plane of the AR HUD device. In this way, it is ensured that the virtual prompt element corresponding to the key object generated through projection conforms to the key object in the actual driving environment, thereby implementing true AR. In addition, in this embodiment of the present disclosure, the target imaging area corresponding to the information display area on the front windshield may be further dynamically adjusted based on the target imaging position of the virtual prompt element corresponding to the key object on the imaging plane, thereby ensuring that the virtual prompt element corresponding to the key object may be always completely displayed in the information display area, and improving richness of information provided by the information display area.

For the information display method described above, the present disclosure further provides a corresponding information display apparatus, so that the foregoing information display method is applied and implemented in practice.

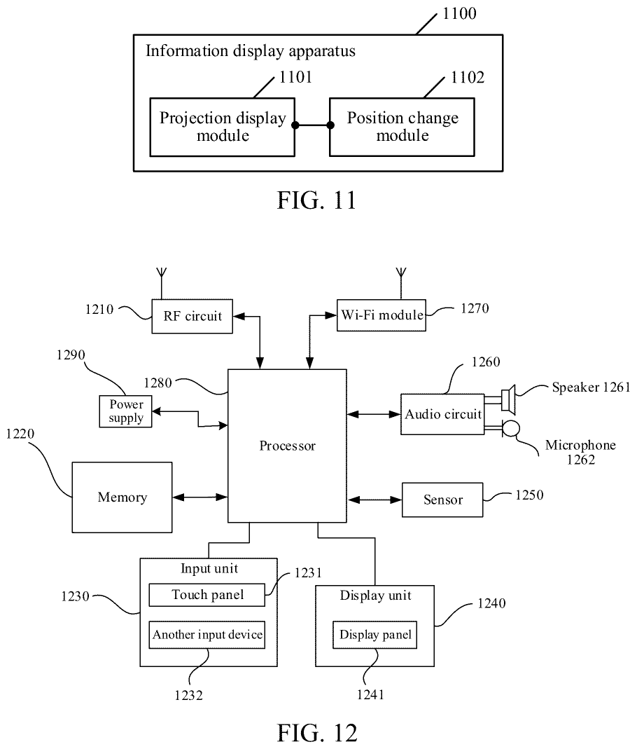

FIG. 11 is a schematic structural diagram of an information display apparatus 1100 corresponding to the information display method shown in FIG. 2 above. As shown in FIG. 11, the information display apparatus 1100 includes:
a projection display module 1101, configured to generate an information display area through a front windshield of a target vehicle, the information display area being generated through projection of an AR HUD device on the target vehicle, the information display area including at least a virtual prompt element corresponding to a key object, the key object being an object in a driving environment where the target vehicle is located, and a display position of the virtual prompt element corresponding to a position of the key object in the driving environment; and
a position change module 1102, configured to change a position of the information display area on the front windshield in response to a change of the key object meeting a preset condition, so that the information display area includes a virtual prompt element corresponding to the key object that is changed.

In some embodiments, the position change module 1102 is specifically configured to:
change the position of the information display area on the front windshield if the key object changes from a first key object to a second key object and a virtual prompt element corresponding to the second key object in the information display area does not meet a first target display condition, so that the virtual prompt element corresponding to the second key object in the information display area meets the first target display condition.

In some embodiments, the position change module 1102 is specifically configured to:
move the position of the information display area on the front windshield upward when the first key object is a target ground object and the second key object is a target overground object, a position of the target ground object being lower than a position of the target overground object; and
move the position of the information display area on the front windshield downward when the first key object is the target overground object and the second key object is the target ground object.

In some embodiments, the position change module 1102 is specifically configured to:
move the position of the information display area on the front windshield rightward when the first key object is a target object on a left side of a line of sight and the second key object is a target object on a right side of the line of sight; and
move the position of the information display area on the front windshield leftward when the first key object is the target object on the right side of the line of sight and the second key object is the target object on the left side of the line of sight.

In some embodiments, the position change module 1102 is specifically configured to:
determine a first imaging position of a virtual prompt element corresponding to the first key object on an imaging plane, and determine a second imaging position of the virtual prompt element corresponding to the second key object on the imaging plane, the imaging plane being a virtual image imaging plane generated through the projection of the AR HUD device; and change the position of the information display area on the front windshield based on a positional relationship between the first imaging position and the second imaging position.

In some embodiments, the position change module 1102 is specifically configured to:
change the position of the information display area on the front windshield if the position of the key object in the driving environment changes from a first position to a second position and a virtual prompt element corresponding to the key object in the information display area does not meet a second target display condition when the key object is in the second position, so that the virtual prompt element corresponding to the key object in the information display area meets the second target display condition when the key object is in the second position.

In some embodiments, the position change module 1102 is specifically configured to:
determine a third imaging position of a virtual prompt element corresponding to the key object on the imaging plane when the key object is in the first position, and determine a fourth imaging position of the virtual prompt element corresponding to the key object on the imaging plane when the key object is in the second position, the imaging plane being a virtual image imaging plane generated through the projection of the AR HUD device; and change the position of the information display area on the front windshield based on a positional relationship between the third imaging position and the fourth imaging position.

In some embodiments, the projection display module 1101 is further configured to:
display, in the information display area when the driving environment includes a plurality of basic key objects and a virtual prompt element corresponding to each of the plurality of basic key objects in the information display area is unable to meet a third target display condition, a virtual prompt element corresponding to a primary key object among the plurality of basic key objects, and display prompt content corresponding to a secondary key object among the plurality of basic key objects based on a preset prompt manner.

In some embodiments, the projection display module 1101 is specifically configured to:
display the prompt content corresponding to the secondary key object based on a target edge area of the information display area, a relative direction between the target edge area and a center of the information display area matching a relative direction between the secondary key object and the target vehicle in the driving environment.

In some embodiments, the apparatus further includes a key object determining module. The key object determining module is configured to:
obtain a reference image captured by a front camera on the target vehicle;
detect candidate key objects included in the reference image through an image detection model; and
determine a key object based on the candidate key objects and a key object determining rule.

In some embodiments, the key object determining module is specifically configured to:
determine an obstacle object at a distance to the target vehicle less than a preset distance threshold as the key object when the target vehicle is in a normal forward-moving state and if the candidate key objects include the obstacle object;
determine lane change prompt information attached to a road surface as the key object when the target vehicle is in a pre-lane change state; and
determine a lane guide sign for an intersection as the key object when the target vehicle is in a pre-intersection arrival state and if the candidate key objects include the lane guide sign.

In some embodiments, the apparatus further includes an object position determining module. The object position determining module is configured to:
determine, based on a position of the front camera in a vehicle coordinate system of the target vehicle and a position of the key object in the reference image, a basic position of the key object in the vehicle coordinate system; and determine a predicted position of the key object at a future reference moment based on a kinematic model corresponding to the target vehicle and the basic position, and use the predicted position as the position of the key object in the driving environment, the kinematic model corresponding to the target vehicle being determined based on a motion state parameter of the target vehicle.

In some embodiments, the apparatus further includes a projection position determining module. The projection position determining module is configured to:
determine a target imaging position of the virtual prompt element corresponding to the key object on the imaging plane based on a position of an eyebox of the AR HUD device in the vehicle coordinate system of the target vehicle and the position of the key object in the driving environment, the imaging plane being a virtual image imaging plane generated through the projection of the AR HUD device; and determine a target imaging area corresponding to the information display area on the imaging plane based on the target imaging position, the target imaging area covering the target imaging position, and a position of the target imaging area on the imaging plane determining the position of the information display area on the front windshield.

According to the information display apparatus provided in the embodiments of the present disclosure, a position of an FOV for imaging of the AR HUD device may be dynamically adjusted based on a change of the key object in the driving environment where the target vehicle is located. In other words, the position of the information display area generated through the projection of the AR HUD device and through the front windshield of the target vehicle on the front windshield may be dynamically adjusted, so that the virtual prompt element corresponding to the key object in the driving environment may be continuously displayed in the information display area, and it is ensured that the display position of the virtual prompt element corresponds to the position of the key object in the driving environment, to provide more realistic prompt information for a driver. According to the information display apparatus provided in the embodiments of the present disclosure, when the key object changes to another FOV from an FOV to which the AR HUD device currently pays attention, the AR HUD device may adjust the position of the information display area generated through the projection thereof on the front windshield, so that the information display area corresponds to the changed FOV. In this way, the information prompted by the AR HUD device is no longer limited to a specific FOV, and may dynamically correspond to a wider FOV. Correspondingly, the driver may learn richer prompt information through the dynamic information display area, thereby improving usage experience.

An embodiment of the present disclosure further provides an electronic device for implementing the foregoing information display method. The electronic device may specifically be a terminal device. The terminal device corresponds to the foregoing controller. The terminal device provided in this embodiment of the present disclosure is described below from a perspective of hardware materialization.

FIG. 12 is a schematic structural diagram of a terminal device according to an embodiment of the present disclosure. As shown in FIG. 12, for ease of description, only parts related to this embodiment of the present disclosure are shown. For specific technical details not disclosed, reference is made to the method part of the embodiments of the present disclosure. The terminal device may be any terminal device such as a mobile phone, a tablet computer, a personal digital assistant (PDA), a point of sales (POS), or an on-board terminal. An example in which the terminal device is an on-board terminal is used.

FIG. 12 is a block diagram of a partial structure of the on-board terminal related to the terminal device according to this embodiment of the present disclosure. Referring to FIG. 12, the on-board terminal includes components such as a radio frequency (RF) circuit 1210, a memory 1220, an input unit 1230 (including a touch panel 1231 and another input device 1232), a display unit 1240 (including a display panel 1241), a sensor 1250, an audio circuit 1260 (which may be connected to a speaker 1261 and a microphone 1262), a wireless fidelity (Wi-Fi) module 1270, a processor 1280, and a power supply 1290. A person skilled in the art may understand that a structure of the on-board terminal shown in FIG. 12 does not constitute a limitation on the on-board terminal, and may include more or fewer components than those shown in the figure, or some merged components, or different component arrangements.

The memory 1220 may be configured to store a software program and a module, and the processor 1280 executes various function applications of the on-board terminal and processes data by running the software program and the module stored in the memory 1220. The memory 1220 may mainly include a program storage area and a data storage area. The program storage area may store an operating system, an application required for at least one function (for example, a sound playback function and an image playback function), and the like. The data storage area may store data (for example, audio data and a phone book) created based on use of the on-board terminal. In addition, the memory 1220 may include a high-speed random access memory (RAM), and may further include a non-volatile memory, such as at least one magnetic disk storage device, a flash memory device, or another volatile solid-state storage device.

The processor 1280 is a control center of the on-board terminal, and configured to connect all parts of the entire on-board terminal by using various interfaces and lines, and executes various functions of the on-board terminal and processes data by running or executing the software program and/or the module stored in the memory 1220 and calling data stored in the memory 1220. In some embodiments, the processor 1280 may include one or more processing units. Preferably, an application processor and a modem processor may be integrated into the processor 1280. The application processor mainly processes an operating system, a user interface, an application, and the like, and the modem processor mainly processes wireless communication. The foregoing modem processor may alternatively not be integrated into the processor 1280.

In this embodiment of the present disclosure, the processor 1280 included in the terminal is further configured to perform the operations of any implementation of the information display method provided in the embodiments of the present disclosure.

An embodiment of the present disclosure further provides a computer-readable storage medium, configured to store a computer program, the computer program being configured to perform any implementation of the information display method described in the foregoing embodiments.

An embodiment of the present disclosure further provides a computer program product or a computer program, the computer program product or the computer program including computer instructions, the computer instructions being stored in a computer-readable storage medium. A processor of a computer device reads the computer instructions from the computer-readable storage medium, and the processor executes the computer instructions, so that the computer device performs any implementation of the information display method described in the foregoing embodiments.

A person skilled in the art may clearly understand that, for convenience and conciseness of description, for specific operating processes of the system, the apparatus, and the units described above, reference may be made to the corresponding processes in the foregoing method embodiments, and the details are not described herein again.

In a plurality of embodiments provided in the present disclosure, the disclosed system, apparatus, and method may be implemented in another manner. For example, the apparatus embodiment described above is merely an example. For example, division into the units or modules is merely logical function division, and may be another division during actual implementation. For example, a plurality of units/modules or components may be combined or integrated into another system, or some features may be ignored or not executed. In addition, the displayed or discussed mutual coupling or direct coupling or communication connection may be implemented through some interfaces. The indirect coupling or communication connection between the apparatuses or units may be implemented in electronic, mechanical, or other forms.

The units/modules described as separate components may or may not be physically separated, and the components displayed as units/modules may or may not be physical units, and may be located in one place or may be distributed on a plurality of network units. Some or all of the units may be selected based on an actual need to achieve the objectives of the solutions of the embodiments.

In addition, the functional units/modules in the embodiments of the present disclosure may be integrated into one processing unit, or each of the units may exist alone physically, or two or more units/modules may be integrated into one unit/module. The foregoing integrated unit may be implemented in a form of hardware, or may be implemented in a form of a software functional unit/module.

If the integrated unit is implemented in the form of the software functional unit and is sold or used as an independent product, the integrated unit may be stored in a computer-readable storage medium. Based on such an understanding, the technical solutions of the present disclosure essentially, or a part contributing to the related art, or all or some of the technical solutions may be implemented in a form of a software product. The computer software product is stored in a storage medium, and includes a plurality of instructions for enabling a computer device (which may be a personal computer, a server, a network device, or the like) to perform all or some of the operations of the method in the embodiments of the present disclosure. The foregoing storage medium includes various media that may store a computer program, such as a USB flash disk, a mobile hard disk, a read-only memory (ROM), a RAM, a magnetic disk, or an optical disk.

In the present disclosure, “at least one (item)” means one or more, and “a plurality of” means two or more. The term “and/or” is used for describing an association relationship between associated objects and representing that three relationships may exist. For example, “A and/or B” may represent the following three cases: only A exists, only B exists, and both A and B exist, where A and B may be singular or plural. The character “/” generally indicates an “or” relationship between a preceding associated object and a succeeding associated object. “At least one of the following items (pieces)” or a similar expression thereof refers to any combination of these items, including a single item (piece) or any combination of a plurality of items (pieces). For example, at least one of a, b, or c may represent a, b, c, “a and b”, “a and c”, “b and c”, or “a, b, and c”, where a, b, and c may be singular or plural.

Based on the above, the foregoing embodiments are merely intended to describe the technical solutions of the present disclosure, and are not intended to limit the present disclosure. Although the present disclosure is described in detail with reference to the foregoing embodiments, a person of ordinary skill in the art is to understand that modifications may still be made to the technical solutions described in the foregoing embodiments, or equivalent replacements may be made to some of the technical features. However, these modifications or substitutions do not make the essence of the corresponding technical solutions depart from the spirit and scope of the technical solutions in the embodiments of the present disclosure.

What is claimed is:

1. An information display method, performed by an electronic device, the method comprising:
projecting, through an augmented reality head up display (AR HUD) device on a target vehicle, an information display area on a front windshield of the target vehicle, the information display area comprising at least a virtual prompt element corresponding to a key object, the key object being an object in a driving environment where the target vehicle is located, and a display position of the virtual prompt element corresponding to a position of the key object in the driving environment; and
changing a position of the information display area on the front windshield in response to a change of the key object meeting a preset condition, wherein the information display area comprises a virtual prompt element corresponding to the key object that is changed.

2. The method according to claim 1, wherein the changing a position of the information display area on the front windshield in response to a change of the key object meeting a preset condition comprises:
changing the position of the information display area on the front windshield in response to that the key object changes from a first key object to a second key object and that a virtual prompt element corresponding to the second key object in the information display area does not meet a first target display condition, wherein the virtual prompt element corresponding to the second key object in the information display area meets the first target display condition.

3. The method according to claim 2, wherein the changing the position of the information display area on the front windshield comprises:
moving the position of the information display area on the front windshield upward when the first key object is a target ground object and the second key object is a target overground object, a position of the target ground object being lower than a position of the target overground object; and
moving the position of the information display area on the front windshield downward when the first key object is the target overground object and the second key object is the target ground object.

4. The method according to claim 2, wherein the changing the position of the information display area on the front windshield comprises:
moving the position of the information display area on the front windshield rightward when the first key object is a target object on a left side of a line of sight and the second key object is a target object on a right side of the line of sight; and
moving the position of the information display area on the front windshield leftward when the first key object is the target object on the right side of the line of sight and the second key object is the target object on the left side of the line of sight.

5. The method according to claim 2, wherein the changing the position of the information display area on the front windshield comprises:
determining a first imaging position of a virtual prompt element corresponding to the first key object on an imaging plane, and determining a second imaging position of the virtual prompt element corresponding to the second key object on the imaging plane, the imaging plane being a virtual image imaging plane generated through the projection of the AR HUD device; and
changing the position of the information display area on the front windshield based on a positional relationship between the first imaging position and the second imaging position.

6. The method according to claim 1, wherein the changing a position of the information display area on the front windshield in response to a change of the key object meeting a preset condition comprises:
changing the position of the information display area on the front windshield in response to that the position of the key object in the driving environment changes from a first position to a second position and a virtual prompt element corresponding to the key object in the information display area does not meet a second target display condition when the key object is in the second position, wherein the virtual prompt element corresponding to the key object in the information display area meets the second target display condition when the key object is in the second position.

7. The method according to claim 6, wherein the changing a position of the information display area on the front windshield comprises:
determining a third imaging position of a virtual prompt element corresponding to the key object on the imaging plane when the key object is in the first position, and determining a fourth imaging position of the virtual prompt element corresponding to the key object on the imaging plane when the key object is in the second position, the imaging plane being a virtual image imaging plane generated through the projection of the AR HUD device; and
changing the position of the information display area on the front windshield based on a positional relationship between the third imaging position and the fourth imaging position.

8. The method according to claim 1, further comprising:
displaying, in the information display area when the driving environment comprises a plurality of basic key objects and a virtual prompt element corresponding to each of the plurality of basic key objects in the information display area does not meet a third target display condition, a virtual prompt element corresponding to a primary key object among the plurality of basic key objects, and displaying prompt content corresponding to a secondary key object among the plurality of basic key objects based on a preset prompt manner.

9. The method according to claim 8, wherein the displaying prompt content corresponding to a secondary key object among the plurality of basic key objects based on a preset prompt manner comprises:
displaying the prompt content corresponding to the secondary key object based on a target edge area of the information display area, a relative direction between the target edge area and a center of the information display area matching a relative direction between the secondary key object and the target vehicle in the driving environment.

10. The method according to claim 1, wherein the key object is determined by:
obtaining a reference image captured by a front camera on the target vehicle;
detecting candidate key objects comprised in the reference image through an image detection model; and
determining the key object based on the candidate key objects and a key object determining rule.

11. The method according to claim 10, wherein the determining the key object based on the candidate key objects and a key object determining rule comprises:
determining an obstacle object at a distance to the target vehicle less than a preset distance threshold as the key object when the target vehicle is in a normal forward-moving state and in response to that the candidate key objects comprise the obstacle object;
determining lane change prompt information attached to a road surface as the key object when the target vehicle is in a pre-lane change state; and
determining a lane guide sign for an intersection as the key object when the target vehicle is in a pre-intersection arrival state and in response to that the candidate key objects comprise the lane guide sign.

12. The method according to claim 1, wherein the position of the key object in the driving environment is determined by:
determining, based on a position of the front camera in a vehicle coordinate system of the target vehicle and a position of the key object in the reference image, a basic position of the key object in the vehicle coordinate system; and
determining a predicted position of the key object at a future reference moment based on a kinematic model corresponding to the target vehicle and the basic position, and using the predicted position as the position of the key object in the driving environment, the kinematic model corresponding to the target vehicle being determined based on a motion state parameter of the target vehicle.

13. The method according to claim 1, wherein the position of the information display area on the front windshield is determined by:
determining a target imaging position of the virtual prompt element corresponding to the key object on the imaging plane based on a position of an eyebox of the AR HUD device in the vehicle coordinate system of the target vehicle and the position of the key object in the driving environment, the imaging plane being a virtual image imaging plane generated through the projection of the AR HUD device; and
determining a target imaging area corresponding to the information display area on the imaging plane based on the target imaging position, the target imaging area covering the target imaging position, and a position of the target imaging area on the imaging plane determining the position of the information display area on the front windshield.

14. An information display apparatus, comprising:
comprising a processor and a memory,
the memory being configured to store a computer program; and
the processor being configured to execute the computer program and perform:
projecting, through an augmented reality head up display (AR HUD) device on a target vehicle, an information display area on a front windshield of the target vehicle, the information display area comprising at least a virtual prompt element corresponding to a key object, the key object being an object in a driving environment where the target vehicle is located, and a display position of the virtual prompt element corresponding to a position of the key object in the driving environment; and
changing a position of the information display area on the front windshield in response to a change of the key object meeting a preset condition, wherein the information display area comprises a virtual prompt element corresponding to the key object that is changed.

15. The apparatus according to claim 14, wherein the changing a position of the information display area on the front windshield in response to a change of the key object meeting a preset condition comprises:
changing the position of the information display area on the front windshield in response to that the key object changes from a first key object to a second key object and that a virtual prompt element corresponding to the second key object in the information display area does not meet a first target display condition, wherein the virtual prompt element corresponding to the second key object in the information display area meets the first target display condition.

16. The apparatus according to claim 15, wherein the changing the position of the information display area on the front windshield comprises:
moving the position of the information display area on the front windshield upward when the first key object is a target ground object and the second key object is a target overground object, a position of the target ground object being lower than a position of the target overground object; and
moving the position of the information display area on the front windshield downward when the first key object is the target overground object and the second key object is the target ground object.

17. The apparatus according to claim 15, wherein the changing the position of the information display area on the front windshield comprises:
moving the position of the information display area on the front windshield rightward when the first key object is a target object on a left side of a line of sight and the second key object is a target object on a right side of the line of sight; and
moving the position of the information display area on the front windshield leftward when the first key object is the target object on the right side of the line of sight and the second key object is the target object on the left side of the line of sight.

18. The apparatus according to claim 15, wherein the changing the position of the information display area on the front windshield comprises:
determining a first imaging position of a virtual prompt element corresponding to the first key object on an imaging plane, and determining a second imaging position of the virtual prompt element corresponding to the second key object on the imaging plane, the imaging plane being a virtual image imaging plane generated through the projection of the AR HUD device; and
changing the position of the information display area on the front windshield based on a positional relationship between the first imaging position and the second imaging position.

19. The apparatus according to claim 14, wherein the changing a position of the information display area on the front windshield in response to a change of the key object meeting a preset condition comprises:
changing the position of the information display area on the front windshield in response to that the position of the key object in the driving environment changes from a first position to a second position and a virtual prompt element corresponding to the key object in the information display area does not meet a second target display condition when the key object is in the second position, wherein the virtual prompt element corresponding to the key object in the information display area meets the second target display condition when the key object is in the second position.

20. A non-transitory computer-readable storage medium, configured to store a computer program, the computer program, when being executed by at least one processor, causing the at least one processor to perform:
projecting, through an augmented reality head up display (AR HUD) device on a target vehicle, an information display area on a front windshield of the target vehicle, the information display area comprising at least a virtual prompt element corresponding to a key object, the key object being an object in a driving environment where the target vehicle is located, and a display position of the virtual prompt element corresponding to a position of the key object in the driving environment; and
changing a position of the information display area on the front windshield in response to a change of the key object meeting a preset condition, wherein the information display area comprises a virtual prompt element corresponding to the key object that is changed.
